(19) United States
(12) Patent Application Publication
(10) Pub. No.: US 2013/0313975 A1
(43) Pub. Date: Nov. 28, 2013

(54) PORTABLE ELECTRIC LAMP HAVING A CURRENT LIMITATION DEVICE

(71) Applicant: ZEDEL, Crolles (FR)

(72) Inventors: Romain PELLAT-FINET, Grenoble (FR); Omar BOUZGHOUB, Domene (FR)

(21) Appl. No.: 13/902,232

(22) Filed: May 24, 2013

(30) Foreign Application Priority Data
May 25, 2012 (FR) 1201511

(51) Int. Cl. H05B 37/03

(52) U.S. Cl. CPC H05B 37/03
USPC 315/127

(57) ABSTRACT

Portable electric lamp including a lighting module, and a compact case containing a power supply for supplying the lighting module and a limitation device for a current delivered by the power supply, the limitation device including a controlled limitation switch coupled between a reference terminal of the power supply and an output terminal of the lighting module, the limitation device being configured so as to determine a supply voltage between an output terminal of the limitation switch and the reference terminal, and to control the limitation switch so that it is in a closed state when the supply voltage is lower than or equal to a desired voltage.

### TECHNICAL FIELD OF THE INVENTION

The invention relates to a portable electric lamp having a current limitation device, and in particular a portable electric lamp used in an environment with an explosive atmosphere, in particular an electric head lamp having a compact case.

### STATE OF THE ART

Currently, compact portable electric lamps are used which include a lighting module in a case having a compact body. Generally, the lamp comprises a support provided with a strap making it possible to carry the lamp on the head. Such lamps can be used in an environment with an explosive atmosphere and must respect restrictive safety requirements. One can mention for example the ATEX directive (Explosive Atmospheres), resulting from European directives relating to equipment and safety environment for workers. Indeed, the current standards impose to limit the supply current for the lighting modules in lamps to such a value that a defect in the lamp can lead neither to a temperature rise nor a spark that could cause an ignition.

Some lamps are equipped with a current limitation device including a resistor in series with a fuse. But this limitation device has the drawback of being energy-consuming in the case of lamps having a powerful lighting. Moreover, this device imposes a nominal operation which is lower by about 1.7 than the thermal limit imposed by the standard, because according to general specifications, the rupture current of a fuse is higher by about 1.7 than the nominal current. In addition, this limitation device requires to replace the fuse after a careless handling by the user, for example when causing a short-circuit with a tool, when immerging the lamp, etc. As a consequence, the lamp must be dismounted or thrown out. Moreover, the temperature of such a limitation device tends to rise, and in a normal use, the allowed maximum current is equal to about 35% of the maximum temperature rise current, in order to be sure that the fuse could not be blown and in order to respect the temperature rise conditions of the lamps fixed by the standards. Such requirements on the maximum current do not allow to use lamps having a high lighting power.

### OBJECT OF THE INVENTION

The object of the invention consists in overcoming these disadvantages, and in particular in producing a portable electric lamp which is sufficiently compact and includes means for limiting the current delivered by the power supply.

Another object of the invention is to propose a portable electric lamp keeping a high level of performance as regards lighting power, autonomy and efficiency.

According to an aspect of the invention, it is proposed a portable electric lamp including a lighting module, and a compact case containing a power supply for supplying the lighting module and a limitation device for a current delivered by the power supply.

The limitation device including a control device, a limitation transistor whose drain is coupled to an output terminal of the lighting module, and gate is coupled to an output terminal of the control device, the limitation device including a resistive element coupled between a reference terminal of the power supply and the source of the limitation transistor.

The control device is configured so as to determine a supply voltage at the terminals of the resistive element, and to control the limitation transistor so that it is in a closed state when the supply voltage is lower than or equal to a desired voltage.

The limitation device moreover comprises a thermal safety device configured so as to maintain the limitation transistor in the opened state when the voltage between the drain and the source of the limitation transistor is higher than a reference voltage.

The limitation device ensures that energy losses are at a minimum, and it is particularly appropriate to powerful lightings. Moreover, such a limitation device makes it possible to control the current limitation so that it is as close as possible to the nominal value of the lamp in use. A thermal limit can thus be reached under nominal operation without exceeding the limit imposed by the standard in the event of a defective lamp.

Thus, it is provided a limitation device which makes it possible to limit the current delivered to the lighting module, while limiting the temperature rise in the lamp. In addition, it is possible to use a maximum delivered current corresponding to about 95% of the maximum temperature rise current fixed by the standards.

The limitation transistor can be a NMOS-type transistor.

The thermal safety device can include a controlled safety switch coupled between the output of the control device and the reference terminal, the thermal safety device being configured so as to maintain the safety switch in a closed state when the voltage between the drain and the source of the limitation transistor is higher than the reference voltage.

According to an embodiment, the safety switch is a bipolar-type transistor whose base is coupled to the output terminal of the lighting module, and the reference voltage is equal to the threshold voltage of the safety transistor.

According to another embodiment, the thermal safety device includes a temperature sensor, and controls the safety switch into the closed state when the temperature of the limitation transistor becomes higher than a reference temperature.

The limitation device can moreover include a voltage comparator having an output coupled to the output terminal of the control device, and two inputs respectively coupled to the two terminals of the resistive element in order to determine the supply voltage.

The lamp can also include an additional limitation device for limiting the supply current delivered by the power supply, the additional limitation device including an additional control device and an additional controlled switch coupled between said limitation transistor and the output terminal of lighting module, the additional controlled switch including a control unit coupled to an output terminal of the additional control device, the additional control device being configured so as to determine the supply voltage and to control the additional switch so that it is in a closed state when the supply voltage is lower than or equal to the desired voltage.

The additional controlled switch can be an additional limitation transistor and the additional limitation device moreover comprises an additional thermal safety device comprising an additional safety bipolar-type transistor, and the additional limitation device is configured so as to maintain the limitation transistors in the opened state when the base-emitter voltage of the safety transistors exceeds their threshold voltage.

### BRIEF DESCRIPTION OF THE DRAWINGS

Other advantages and features will more clearly arise from the following description of particular embodiments of the invention given as nonrestrictive examples and represented in the annexed drawings, in which:

FIGS. 1 and 2 schematically illustrate embodiments of a portable electric lamp according to the invention.

### DETAILED DESCRIPTION

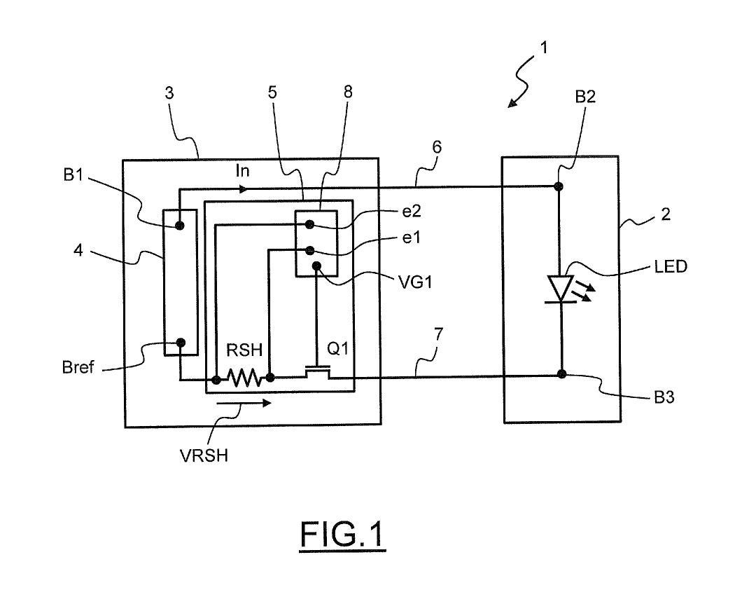

In FIG. 1, it is schematically represented a portable electric lamp 1 including a lighting module 2 and a compact case 3 containing a power supply 4, such as a cell or a battery, for delivering a supply current In to the lighting module 2, and a current limitation device 5 for limiting the supply current In. Preferably, the lighting module 2 comprises an electroluminescent diode (LED) and lighting controls. The lighting module 2 can also comprise several LEDs, in particular high power LEDs. The portable electric lamp 1 can be a head lamp, or a flashlight, and the compact case 3 can be made out of a metal or an insulating material. According to an embodiment, the lighting module 2 is separated from the compact case 3, and the power supply 4 is coupled to the lighting module 2 via electric wires 6, 7, each of them being included in an insulating sleeve. According to another embodiment, the lighting module 2 is included within the compact case 3. Moreover, the power supply 4 includes a reference terminal Bref and an output terminal B1 for delivering the current In. The lighting module 2 comprises an input terminal B2 and an output terminal B3 respectively coupled to the electric wires 6, 7 for supplying the LED. The limitation device 5 comprises a control device 8, a controlled electronic switch Q1, called limitation switch, and a resistive element RSH, preferentially a resistor. The limitation switch Q1 is coupled between the reference terminal Bref, via the resistive element RSH, and the output terminal B3 of the lighting module 2. Moreover, the limitation switch Q1 comprises a control element coupled to an output terminal VG1 of the control device 8. The control device 8 moreover comprises two inputs e1, e2, respectively coupled to the terminals of the resistive element RSH so that it is possible to determine a supply voltage VRSH between an output terminal of the switch Q1 and the reference terminal Bref. The limitation switch Q1 can be a MEMS-type switch (MEMS: Micro Electro Mechanical System) or a transistor, preferably a NMOS-type transistor.

The control device 8 is configured so as to control the opening and closing of the limitation switch Q1. In a general way, the control device 8 controls the limitation switch Q1 so that it is in a closed state when the supply voltage VRSH is lower than or equal to a desired voltage Vpont and, otherwise, it is in an opened state. Thus, under normal operation, the supply voltage VRSH is lower than Vpont and the switch Q1 is in the closed state in order to supply the LED. In the event of a short-circuit, the supply voltage is higher than Vpont, the control device 8 controls the opening of the switch Q1 and the value of the supply current In falls. Thus, the supply voltage VRSH also falls until being lower than Vpont, and the control device 8 controls the closing of the switch Q1 again in order to supply the LED. In particular the desired voltage Vpont is adjusted so as to be equal to the voltage at the terminals of the resistive element RSH when a desired maximum current Imax flows therethrough. The maximum current Imax is determined so that the temperature of the lamp 1 does not rise, which could cause otherwise an ignition, even if the control device 8 and/or the limitation device 5 is defective.

Thus, such a limitation device 5 allows to limit the supply current In delivered to the LED, in particular to limit the supply current In to the maximum value Imax, such as:

Imax=Vpont/RSH

where
Imax is the maximum current delivered to the LED;
Vpont is the desired voltage;
RSH is the value of the resistance of the resistive element.

Such a limitation device 5 is particularly appropriate for LEDs having a high power lighting, which require to be supplied by a power supply 4 configured so as to deliver a supply current In superior to 1 Amp, preferably of about 1 Amp. For example, one can desire a maximum current Imax=1.5 A which does not generate an excessive temperature rise, and have Rsh=100 MO and Vpont=0.15 Volt.

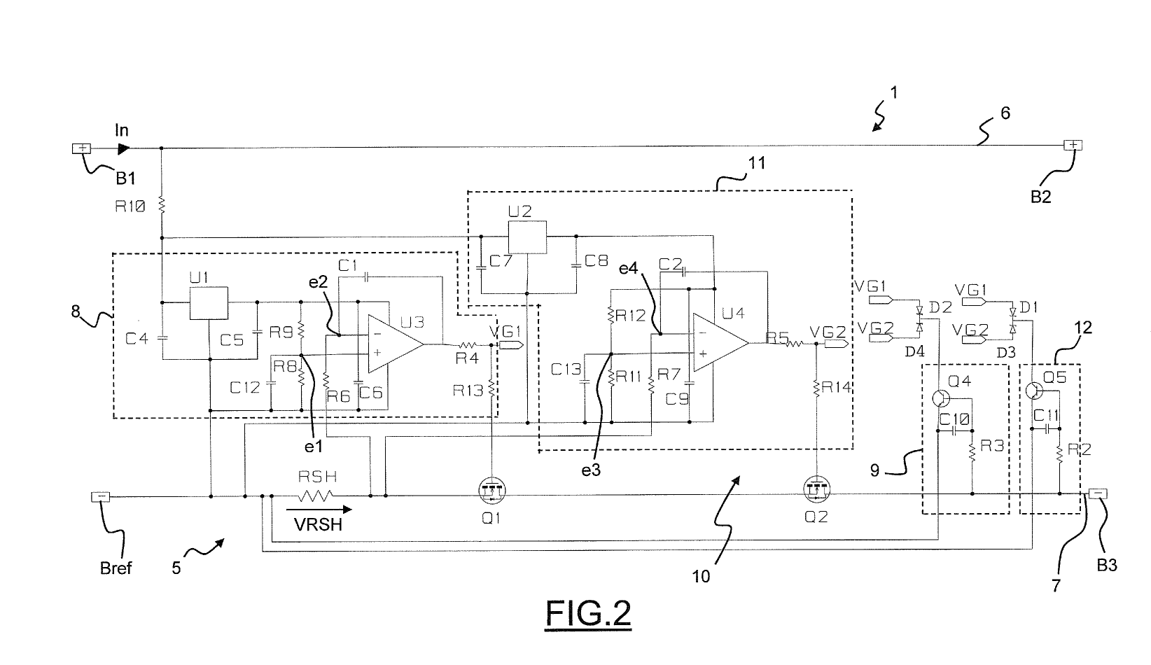

In FIG. 2 it is schematically represented another embodiment of the portable electric lamp 1. In this figure are also represented some elements described in FIG. 1. In this other embodiment, the limitation switch Q1 is a NMOS-type transistor whose gate is coupled to the output VG1, via a resistor R13, the source is coupled to one terminal of the resistor RSH and the drain is coupled to the output B3 of the lighting module 2, either directly or via an additional electronic switch Q2 whose role will be described later on. Moreover, the control device 8 comprises an operational amplifier U3 configured as a voltage comparator. The amplifier U3 comprises first and second inputs +,− respectively coupled to the inputs e1, e2 of the control device 8, and an output coupled to the output VG1, via a resistor R4. In addition, the output of the amplifier U3 is coupled to the second input e2 via a bypass capacitor C1, the first input el of the control device 8 is coupled to the reference terminal Bref, via a resistor R8 and a bypass capacitor C12 in parallel, and the second input e2 is coupled to the source Q1 via a resistor R6. Moreover, the control device 8 comprises a resistor R9 coupled between the first input el and the positive supply terminal of the amplifier U3. The control device 8 also comprises a voltage regulator U1 and other bypass capacitors C4 to C6 so as to provide a stable desired voltage Vpont. Moreover, the regulator U1 makes it possible to provide a stable voltage for supplying the operational amplifier U3.

Advantageously, the limitation device 5 can include a resistor R10 coupled between the voltage regulator U1 and the output terminal B1 of the power supply. The resistor R10 makes it possible to limit the available power for the control device 8.

The resistors R8, R9 make it possible to get the desired voltage Vpont so that Vpont=(R8/(R8+R9)) Vref, where Vref represents the voltage at the terminals of the resistors R8 and R9 in series. The resistor RSH makes it possible to cause a voltage drop VRSH, image of the current flowing therethrough, i.e. the supply current In delivered to the LED. In other words, the operational amplifier U3 controls the supply current In by comparing the supply voltage VRSH with the desired voltage Vpont. Moreover, the amplifier U3 provides a control voltage Vout at the gate of the transistor Q1 for controlling it.

When the LED is supplied, it consumes a current In lower than Imax and the voltage supply VRSH is lower than Vpont. In that case, the difference between the desired voltage and the supply voltage Vpont-VRSH is positive, and the output voltage Vout of the amplifier U3 is saturated in a high state and is equal to Vref. The limitation transistor Q1 is then controlled with a gate voltage VGS equal to Vref, it is in an on-state, and the supply current In flows through the LED.

When the lamp 1 is defective, for example in the event of a short-circuit, the supply current In increases and becomes higher than Imax. In that case, the supply voltage VRSH becomes higher than Vpont, the inputs +,− of the amplifier U3 are reversed and the voltage Vout at the output falls. The limitation transistor Q1 is not conductive anymore because the gate voltage VGS does not allow anymore to control the limitation transistor Q1 and the supply current In falls. It is thus a linear operation in which the amplifier U3 controls the transistor Q1 in a stable working point allowing the circulation of the supply current In whose value is equal to Imax.

The limitation device 5 can moreover include a thermal safety device 9 in order to avoid an excessive temperature rise in the limitation transistor Q1. In other words, the thermal safety device 9 prevents the power dissipated within the limitation transistor Q1 from exceeding a certain threshold corresponding to an excessive temperature rise. The thermal safety device 9 is configured so as to maintain the limitation switch Q1 in the opened state when the temperature of the limitation switch Q1 becomes higher than a reference threshold. Thus, the supply current of the LED is limited while preventing the temperature of the limitation switch Q1 from rising. Indeed, in the event of a short-circuit, the switch Q1 is in the closed state so that a maximum current Imax can flows therethrough for a certain time, which generate a temperature rise in the switch Q1. It is possible to reduce the temperature rise in the limitation transistor Q1 by using a limitation transistor Q1 having an important size. Advantageously, the thermal safety device 9 makes it possible, in particular, to reduce the size of the limitation transistor Q1 used and thus to make the lamp 1 more compact.

For example, the thermal safety device 9 can include a controlled electronic safety switch Q4, preferably a NPN-type bipolar transistor, coupled between the output VG1 of the control device 8, via a diode D2, and the reference terminal Bref, and whose base is coupled to the output terminal B3 of the lighting module 2 via a resistor R3. Advantageously, the thermal safety device 9 comprises a bypass capacitor C10 in parallel with the resistor R3. Thus, the safety transistor Q4 is configured so as to be in a off-state, in which it is not conductive, when its base-emitter voltage Vbe is lower than its threshold voltage, for example 0.7 Volt. Moreover, the safety transistor Q4 is in an on-state, in which it is conductive, when its base-emitter voltage Vbe is higher than or equal to its threshold voltage. According to the connection of the safety transistor Q4, there is the following relation:

Vbe=VRSH+VQ1

where
Vbe is the base-emitter voltage of the safety transistor Q4;
VRSH is the voltage at the terminals of the resistor RSH;
VQ1 is the voltage at the terminals of the limitation transistor Q1, i.e. the voltage between the drain and the source of the transistor Q1.

Under normal operation, i.e. when there is no short-circuit, the supply current In is lower than Imax, VRSH is lower than Vpont, and the voltage VQ1 is null. The base-emitter voltage Vbe of the safety transistor Q4 is thus equal to VRSH. Consequently, the base-emitter voltage Vbe of the safety transistor Q4 is lower than its threshold voltage and the transistor Q4 is not conductive. In the event of a short-circuit, a current Imax flows through the limitation transistor Q1 and the voltage VQ1 increases until reaching a value equal to the difference Vref-VRSH between the voltage at the terminals of the resistors R8 and R9 in series and the voltage at the terminals of the resistor RSH, with Vref having a value higher than the threshold voltage of the safety transistor Q4. In that case, it is considered that the temperature in the limitation transistor Q1 rises beyond an acceptable limit. According to the relation Vbe=VRSH+VQ1, the base-emitter voltage Vbe of the safety transistor Q4 also increases and becomes higher than its threshold voltage, and the safety transistor Q4 is conductive. Moreover, when the safety transistor Q4 is conductive, the diode D2 makes the output voltage Vout of the amplifier U3 equal to the value of the voltage at the reference terminal Bref. In that case, the gate voltage of the limitation transistor Q1 is equal to that of the reference terminal Bref and the limitation transistor Q1 is then in the off-state in which it is not conductive. Thus the limitation device 5 is electrically insulated, the voltage VRSH falls and the supply current In becomes null, which prevents the temperature in the limitation transistor Q1 from rising. Preferably, it is chosen for the desire voltage Vpont a value which is lower than the threshold voltage of the safety transistor Q4.

In a variant, the thermal safety device 9 can include a voltage comparator configured so as to control the safety transistor Q4 into the closed state when the voltage at the terminals of the limitation transistor Q1 is higher than a reference voltage for which it is considered that there is a temperature rise in the transistor Q1. For example, the reference voltage is equal to the threshold voltage of the safety transistor Q4.

According to another variant, the thermal safety device 9 includes a temperature sensor, and is moreover configured so as to control the safety switch Q4 into the closed state when the temperature of the limitation switch Q1 becomes higher than a reference temperature for which it is considered that the limitation transistor Q1 has reached a temperature rise limit.

Advantageously, the portable electric lamp 1 can comprise an additional limitation device 10 for ensuring a redundancy of the limitation of the supply current In. The additional limitation device 10 comprises an additional control device 11 for controlling the additional electronic switch Q2, called additional limitation switch. The additional limitation switch Q2 can be a MEMS-type switch. Preferably, the additional limitation switch Q2 is a NMOS-type transistor whose source is coupled to the drain of the limitation transistor Q1, the drain is coupled to the output B3 of the lighting module 2 and the gate is coupled to an output VG2 of the additional control device 11 via a resistor R14. The additional control device 11 comprises two inputs e3, e4, respectively coupled to the terminals of the resistive element RSH so as to be able to determine the supply voltage VRSH. Moreover, the additional control device 11 comprises an operational amplifier U4 configured as a voltage comparator. The amplifier U4 comprises first and second inputs +,− respectively coupled to the inputs e3, e4 of the additional control device 11, and an output coupled to the output VG2, via a resistor R5. In addition, the output of the amplifier U4 is coupled to the second input e4 via a bypass capacitor C2, the first input e3 of the additional control device 11 is coupled to the reference terminal Bref, via a resistor R11 and a bypass capacitor C13 in parallel, and the second input e4 is moreover coupled to the source of the limitation transistor Q1 via a resistor R7. The additional control device 11 moreover comprises a resistor R12 coupled between the first input e3 and the positive supply terminal of the amplifier U4. The additional control device 11 also comprises a voltage regulator U2 and other bypass capacitors C7 to C9 so as to provide a second stable desired voltage Vpont2 to the amplifier U4. The second desired voltage Vpont2 is determined by the following relation: Vpont2 =(R11/(R11+R12)) Vref2; where Vref2 represents the voltage at the terminals of the resistors R11 and R12 in series. Preferably, the second desired voltage Vpont2 is equal to the first voltage Vpont. The additional control device 11 is configured so as to control the additional limitation switch Q2 so that it is in a closed state when the supply voltage VRSH is lower than or equal to the second desired voltage Vpont2, and otherwise it is in an opened state. Moreover, the safety transistor Q4 has its emitter coupled to the output VG2 of the additional control device 11 via an additional diode D4. Thus the thermal safety device 9 prevents the temperatures in the two limitation transistors Q1, Q2 from rising.

Advantageously, the additional limitation device 10 can moreover include an additional thermal safety device 12 configured so as to maintain the limitation switches Q1, Q2 in the opened state when the temperature of at least one limitation switch Q1, Q2 becomes higher than a reference threshold. For example, the additional thermal safety device 12 includes a controlled additional electronic safety switch Q5, preferably a NPN-type bipolar transistor, coupled between the reference terminal Bref, and on the one hand the output VG1 of the control device 8, via a diode D1, and on the other hand the output VG2 of the additional control device 11, via another diode D3. Moreover, the base of the additional safety transistor Q5 is coupled to the output B3 of the lighting module 2 via a resistor R2. Advantageously, the additional thermal safety device 12 comprises a bypass capacitor C11 in parallel with a resistor R2.

Thus, under normal operation, the supply voltage VRSH is lower than the desired voltages Vpont and Vpont2, and the limitation transistors Q1 and Q2 are in an on-state for supplying the LED.

In the event of a short-circuit, the supply voltage VRSH is higher than the desired voltages Vpont, Vpont2 and the control devices 8, 11 respectively control the limitation transistors Q1, Q2 into the non-conductive state. Thus, the supply voltage VRSH falls until being lower than the desired voltages Vpont, Vpont2 and the control devices 8, 11 control again the closing of the limitation transistors Q1, Q2 for supplying the LED. Thus, the supply current In is limited to the maximum value Imax. Moreover, when the voltage at the terminals of the limitation transistors Q1, Q2 increases and the temperatures in the transistors Q1, Q2 rise, the base-emitter voltage Vbe of the safety transistors Q4, Q5 then exceeds their threshold voltage, and the safety transistors Q4, Q5 become conductive. Thus, the limitation transistors Q1, Q2 are maintained in the off-state in which their temperatures do not rise anymore.

Such a lamp equipped with both a current limitation device and a thermal safety device is particularly appropriate to a use in an environment with an explosive atmosphere.

1. Portable electric lamp including:
a lighting module, and
a compact case containing a power supply for supplying the lighting module and a limitation device for a current delivered by the power supply,
the limitation device including:
a control device,
a limitation transistor whose drain is coupled to an output terminal of the lighting module, and gate is coupled to an output terminal of the control device,
the limitation device including a resistive element coupled between a reference terminal of the power supply and the source of the limitation transistor,
the control device being configured so as to determine a supply voltage at the terminals of the resistive element, and to control the limitation transistor so that it is in a closed state when the supply voltage is lower than or equal to a desired voltage,
wherein the limitation device moreover comprises a thermal safety device configured so as to maintain the limitation transistor in the opened state when the voltage between the drain and the source of the limitation transistor is higher than a reference voltage.

2. Lamp according to claim 1, in which the limitation transistor is a NMOS-type transistor.

3. Lamp according to claim 1, in which the thermal safety device includes a controlled safety switch coupled between the output of the control device and the reference terminal, the thermal safety device being configured so as to maintain the safety switch in a closed state when the voltage between the drain and the source of the limitation transistor is higher than the reference voltage.

4. Lamp according to claim 3, in which the safety switch is a bipolar-type transistor whose base is coupled to the output terminal of the lighting module, and the reference voltage is equal to the threshold voltage of the safety transistor.

5. Lamp according to claim 3, in which the thermal safety device includes a temperature sensor, and controls the safety switch into the closed state when the temperature of the limitation transistor becomes higher than a reference temperature.

6. Lamp according to claim 1, in which the limitation device includes a voltage comparator having an output coupled to the output terminal of the control device, and two inputs respectively coupled to the two terminals of the resistive element in order to determine the supply voltage.

7. Lamp according to claim 1, including an additional limitation device for limiting the supply current delivered by the power supply, the additional limitation device including an additional control device and an additional controlled switch coupled between said limitation transistor and the output terminal of lighting module, the additional controlled switch including a control unit coupled to an output terminal of the additional control device, the additional control device being configured so as to determine the supply voltage and to control the additional switch so that it is in a closed state when the supply voltage is lower than or equal to the desired voltage.

8. Lamp according to claim 7, in which the additional controlled switch is an additional limitation transistor and the additional limitation device moreover comprises an additional thermal safety device comprising an additional safety bipolar-type transistor, and the additional limitation device is configured so as to maintain the limitation transistors in the opened state when the base-emitter voltage of the safety transistors exceeds their threshold voltage.
